(19) United States
(12) Patent Application Publication
(10) Pub. No.: US 2005/0051238 A1
(43) Pub. Date: Mar. 10, 2005

(54) Micro-adjustment device for the angle stop plank of a planer

(76) Inventor: Bor Yann Chuang, Taichung (TW)

Correspondence Address: TROXELL LAW OFFICE PLLC, 5205 LEESBURG PIKE, SUITE 1404, FALLS CHURCH, VA, 22041, US

(21) Appl. No.: 10/656,324

(22) Filed: Sep. 8, 2003

(51) Int. Cl. B27C 1/00

(52) U.S. Cl. 144/114.1

(57) ABSTRACT

A micro-adjusting device for the angle stop plank of a planer includes a hand wheel unit provided on the holding frame and having a worm, a transmission rod provided in the holding frame to be rotated by the worm, an upper connecting rod meshed with and actuated to move back and forth by a transmission gear fixed on one end of the transmission rod and having one end pivotally connected with a stop plank, and a lower connecting rod having its opposite ends respectively connected pivotally with the stop plank and the holding frame to form two pivotal joints serving as turning fulcrums. When the hand wheel unit is turned around, the upper connecting rod is actuated to pull or push the upper portion of the stop plank, and the lower connecting rod together with the turning fulcrums micro-adjusts the stop plank at a required angle.

### BACKGROUND OF THE INVENTION

1. Field of the Invention

This invention relates to a micro-adjustment device for the angle stop plane of a planer, particularly to one able to micro-adjust the slanting angles of the angle stop plank of a planer accurately and quickly.

2. Description of the Prior Art

A conventional planer has a stop plank positioned stationary on its wood conveying table, always maintaining a single angle between the stop plank and the wood conveying table; therefore after a wood material is positioned to lean on the stop plank for planing, it can be planed only at a single angle, impossible to be planed at a specific angle. To carry out planing at a specific angle, it is necessary to draw a line on wood material in advance and then perform planing with help of certain auxiliary tools, impossible to plane the wood material with great accuracy, inconvenient in planing wok and likely to cause danger during planing. In view of the above-mentioned drawback, another conventional planer is provided with an adjustable stop plank which can be adjusted and positioned at frequently employed angles, such as an interior angle of 45 degrees, a right angle or an exterior angle of 45 degrees, able to carry out planing at a specific angle safely and conveniently.

However, although the stop plank of the conventional planer can be adjusted and positioned at certain specific angles, yet such a design cannot fully meet the needs in planing work because many wood materials may be required to be planed at other different angles rather than at the foresaid specific angles.

### SUMMARY OF THE INVENTION

A main objective of the invention is to offer a micro-adjustment device for the angle stop plank of a planer, able to accurately micro-adjust the stop plank of a planer at any angle from an interior angle of 45 degrees to an exterior angle of 45 degrees by turning around a hand wheel.

Another objective of the invention is to offer a micro-adjustment device for the angle stop plank of a planer, able to have the angle stop plank accurately and quickly adjusted at one of frequently employed specific angles, such as an interior angle of 45 degrees, a right angle and an exterior angle of 45 degrees without help of a graduation ruler.

### BRIEF DESCRIPTION OF DRAWINGS

This invention will be better understood by referring to the accompanying drawings, wherein:

FIG. 1 is a partial perspective view of a micro-adjustment device for the angle stop plank of a planer in the present invention:

FIG. 2 is an exploded perspective view of the micro-adjustment device for the angle stop plank of a planer in the present invention:

FIG. 3 is a top view of the micro-adjustment device for the angle stoop plank of a planer in the present invention:

FIG. 4 is a bottom view of the micro-adjustment device for the angle stop plank of a planer in the present invention:

FIG. 5 is a perspective view of the upper connecting rod of the micro-adjustment device for the angle stop plank of a planer in the present invention:

FIG. 6 is a cross-sectional view of the micro-adjustment device for the angle stop plank of a planer in the present invention, showing the angle stop plank adjusted and positioned at a right angle:

FIG. 7 is a cross-sectional view of the micro-adjustment device for the angle stop plank of a planer in the present invention, showing the angle stop plank adjusted and positioned at an exterior angle of 45-degrees: and

FIG. 8 is a cross-sectional view of the micro-adjustment device for the angle stop plank of a planer in the present invention, showing the angle stop plank adjusted and positioned at an interior angle of 45-degrees.

### DETAILED DESCRIPTIN OF THE PREFERRED EMBODIMENT

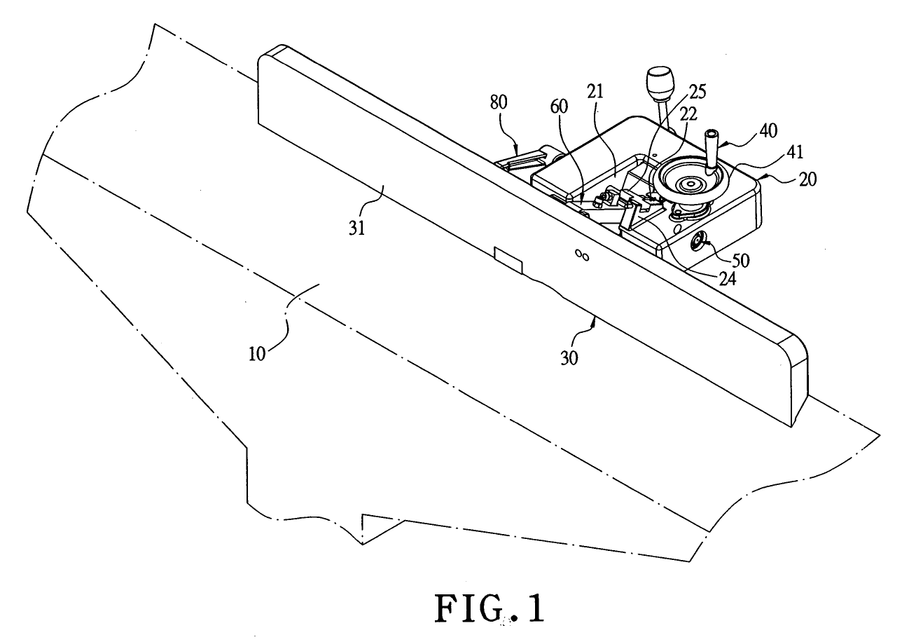

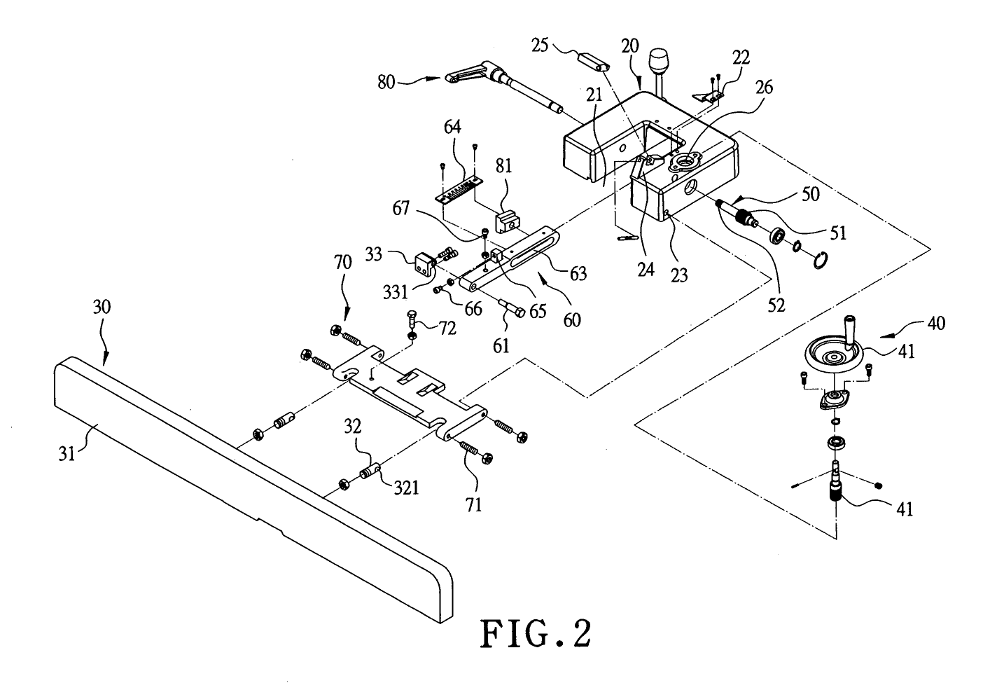

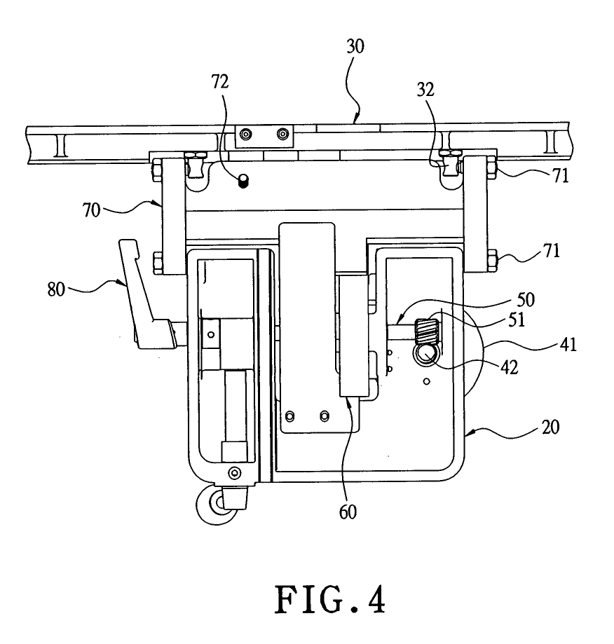

A preferred embodiment of a micro-adjustment device for the angle stop plank of a planer in the present invention, as shown in FIGS. 1 to 4, includes a wood-conveying table 10, a holding frame 20, a stop plank 30, a hand wheel unit 40, a transmission rod 50, an upper connecting rod 60, a lower connecting rod 70 and a locking handle 80 combined together.

The wood-conveying table 10 has one side combined with the upper holding frame 20 connected with the stop plank 30, which is located at one side on the topside of the wood-conveying table 10 for a wood material to be leaned thereon during planing.

The holding frame 20 is an inverted-U shaped body, having an accommodating space 21 formed in the center, and an index hand 22 provided at a preset location of the topside and pointing to one side of the accommodating space 21.

The stop plank 30 has its front side formed with a leaning surface 31 for a wood material to lean thereon and its rear lower side locked with two connecting bolts 32 separately positioned at preset locations and respectively having a lateral insert hole 321. The stop plank 30 further has a rod-connecting base 33 with a lateral shaft hole 331 secured near the upper edge of its rear central wall.

The hand wheel unit 40 consists of a hand wheel 41 and a worm 42 actuated to rotate by the hand wheel 41. The worm 42 is vertically inserted in a through hole 26 in the topside of the holding frame 20.

The transmission rod 50 to be transversely inserted in the holding frame 20 and positioned at the lower end of the worm 42 of the hand wheel unit 40. The transmission rod 50 has one end provided with a worm wheel 51 to be meshed with the worm 42 and the other end formed with a transmission gear 52.

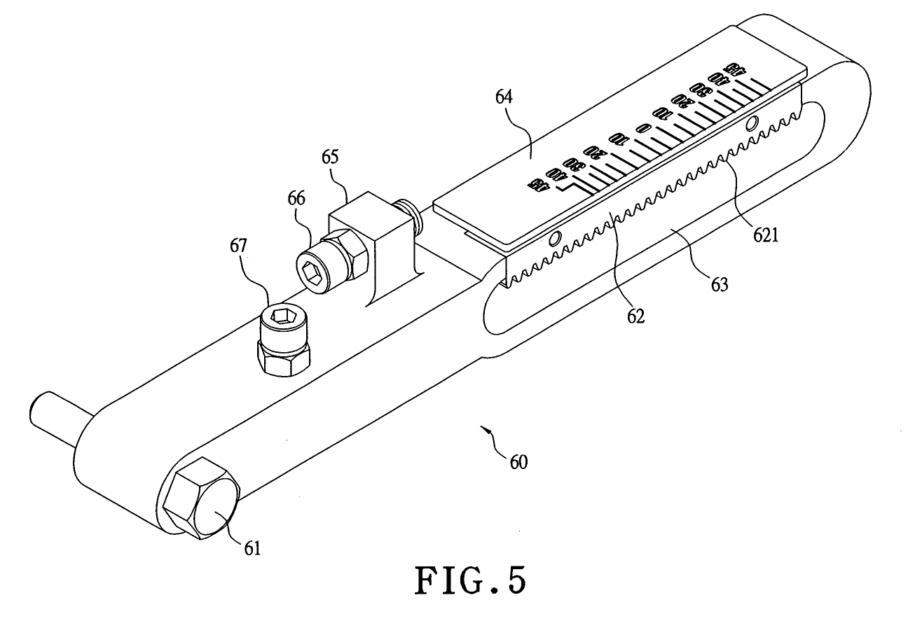

The upper connecting rod 60, as shown in FIG. 5., to be positioned in the accommodating space 21 of the holding frame 20, is provided with a bolt 61 at the front end to be inserted in the shaft hole 331 of rod-connecting base 33 fixed at the rear wall of the stop plank 30, and a rack 62 at the rear upper side, with a guiding groove 63 formed beneath the rack 62, which is formed with multiple row teeth 621 to be meshed with the transmission gear 52 of the transmission rod 50. Further, the upper connecting rod 60 has the topside above the guiding groove 63 provided with a graduation ruler 64 having angle graduations marked thereon. Thus, the graduation ruler 64 on the upper connecting rod 60 in cooperation with the index hand 22 on the holding frame 20 can indicate the positioning angle of the stop plank 30 after it is adjusted.

The lower connecting rod 70 shaped a plate has two bolts 71 respectively provided at the opposite ends of its rear side to be respectively and pivotally inserted in two insert holes 23 at the opposite lower front sides of the holding frame 20, and another two bolts 71 respectively provided at the opposite ends of its front side to be respectively and pivotally inserted in the two insert holes 321 of the two connecting bolts 32 of the stop plank 30. Thus, the pivotal joints of the lower connecting rod 70 with the holding frame 20 and the stop plank 30 respectively make up a turning fulcrum.

The locking handle 80 is transversely and pivotally inserted in the left side of the holding frame 20 and positioned opposite to the worm 42. The locking handle 80 has its end screwed with a locking block 81 to be fitted in the opposite side of the guiding groove 63 of the upper connecting rod 60 and limited to rotate therein. Thus, when the locking handle 80 is turned and locked tightly, its locking block 81 will be actuated to push tightly against or release the upper connecting rod 60.

In addition, the micro-adjustment device of this invention is also provided with three positioning methods able to quickly position the stop plank at three specific angles.

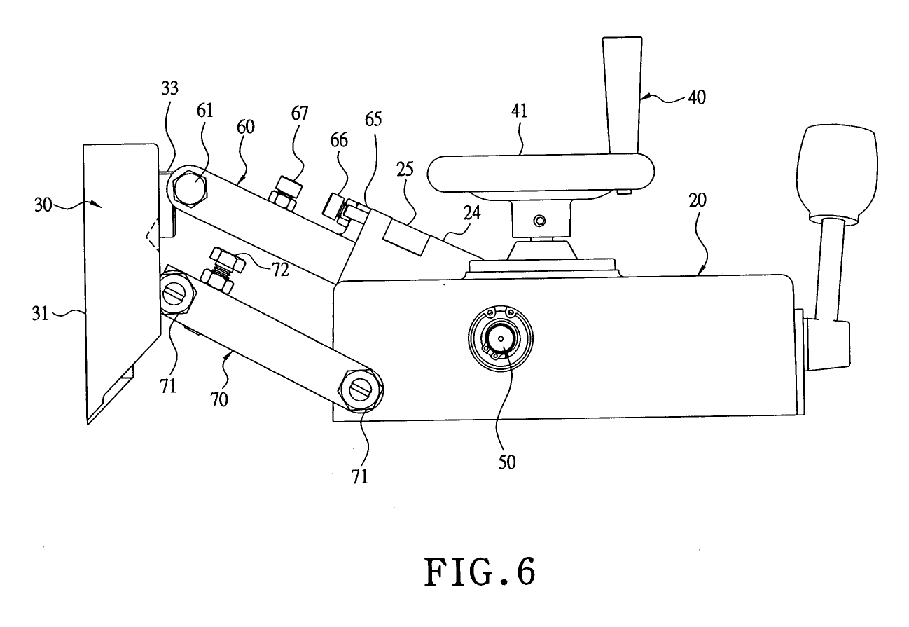

1. A positioning method of a right angle: Referring to FIG. 6, the holding frame 20 is formed integral with a stop base 24 protruding upward on one side abutting the upper connecting rod 60. The stop base 24 is pivotally provided with a stop block 25 able to be rotated and positioned on the topside of the upper connecting rod 60 in due time. The upper connecting rod 60 is provided with a bolt base 65 protruding upward at a preset location on the topside and having a stop bolt 66 screwed thereon. Thus, when the stop plank 30 is turned and adjusted, the stop bolt 66 of the upper connecting rod 60 and the stop block 25 of the holding frame 20 will push against each other and quickly position the stop plank 30 at the angle of 90 degrees.

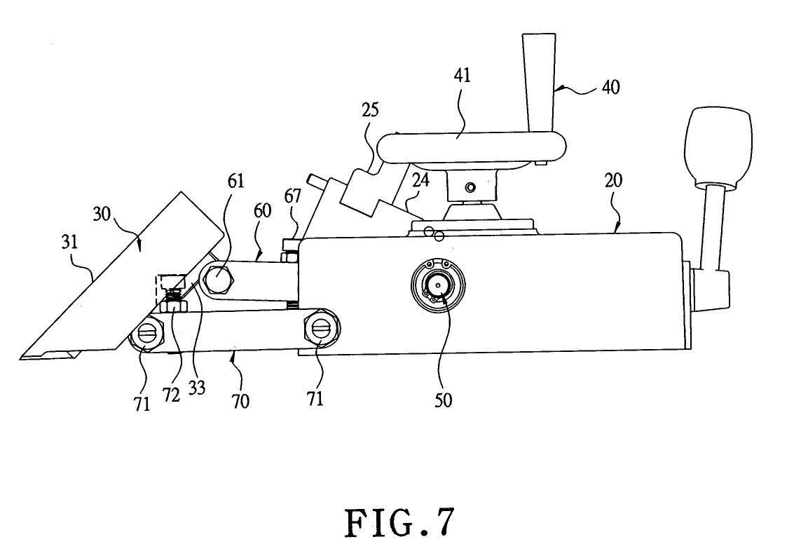

2. A positioning method of an exterior angle of 45 degrees: Referring to FIG. 7, the lower connecting rod 70 is provided with a stop blot 72 at a preset location on the topside. Thus, when the stop plank 30 is turned and adjusted, the stop bolt 72 of the lower connecting rod 70 will push against a preset part on the rear wall of the stop plank 30 and quickly position the stop plank 30 at the exterior angle of 45 degrees.

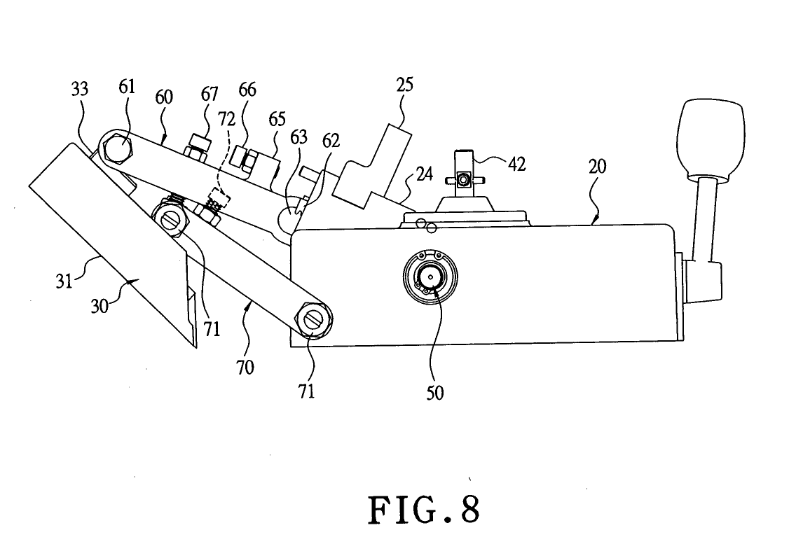

3. A positioning method of an interior angle of 45 degrees: Referring to FIG. 8, the upper connecting rod 60 is provided with a stop bolt 67 in front of the bolt base 65 on its topside. Thus, when the stop plank 30 is turned and adjusted, the stop bolt 67 will push against a preset part on the topside of the lower connecting rod 70 and quickly position the stop plank 30 at the interior angle of 45 degree.

In operating and using, as shown in FIGS. 6, 7 and 8, before the stop plank 30 is adjusted, the stop bolt 66 on the upper connecting rod 60 for positioning an angle of 90 degrees and the stop bolt 67 for positioning an exterior angle of 45 degrees and the stop bolt 72 on the lower connecting rod 70 for positioning an interior angle of 45 degrees are respectively screwed and adjusted to an accurate position. Thus, when the hand wheel 41 is turned around, the upper connecting rod 60 will be actuated by the worm 42 and the transmission rod 50 to pull or push the stop plank 30, and simultaneously the stop plank 30 will be turned in a specific direction by means of the turning fulcrums respectively formed at the pivotal joints at the front and the rear end of the lower connecting rod 70.

Specifically, to position the stop plank 30 at the interior angle of 45 degrees, the hand wheel 41 is turned in a proper direction to let its worm 42 actuate the worm wheel 51 of the transmission rod 50 to rotate. In the meantime, the transmission rod 50 rotates, having its transmission gear 52 actuate the row teeth 621 together with the upper connecting rod 60 to move forward and push the stop plank 30 to force the upper portion of the stop plank 30 to slant outward until the stop bolt 67 adjusted in advance on the upper connecting rod 60 exactly pushes against the topside of the lower connecting rod 70, thus able to position the stop plank 30 at the interior angle of 45 degrees.

To position the stop plank 30 at the right angle, the stop block 25 on the holding frame 20 is pulled toward the upper connecting rod 60 and lies on the topside of the upper connecting rod 60. Then, the hand wheel 41 is turned counterclockwise to let the row teeth 621 of the upper connecting rod 60 actuated by the transmission gear 52 of the transmission rod 50 to move backward and pull the stop plank 30 until the stop bolt 66 adjusted in advance on the upper connecting rod 60 exactly pushes against the stop block 25, thus able to position the stop plank 30 at the right angle.

To position the stop plank 30 at the exterior angle of 45 degrees, the stop block 25 of the holding frame 20 is pulled outward to enable the upper connecting rod 60 to move backward smoothly. Then, the hand wheel 41 is turned around to let the row-teeth 621 together with the upper connecting rod 60 actuated by the transmission gear 52 of the transmission rod 50 to move backward and pull the stop plank 30 until a preset part on the rear wall of the stop plank 30 exactly pushes against the stop bolt 72 on the topside of the lower connecting rod 70, thus able to position the stop plank 30 at an exterior angle of 45 degrees. The scope of the adjustable angle of the stop plank 30 is 90 degrees from the interior 45 degrees to the exterior 45 degrees.

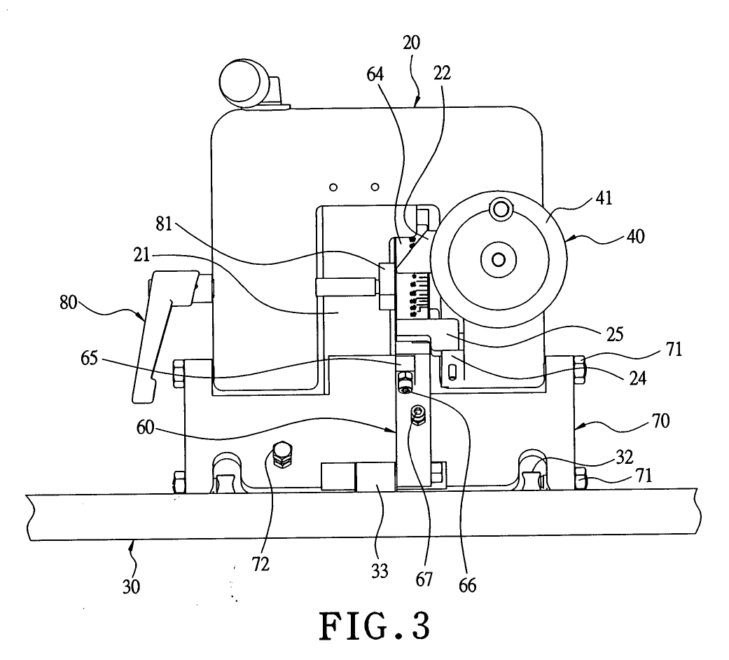

Apart from being quickly positioned at the above-mentioned specific angles, the stop plank 30 can also be precisely micro-adjusted at any angle, as shown in FIG. 3. To micro-adjust the stop plank 30, the hand wheel 41 is turned around to actuate the upper connecting rod 60 to move back or forth and push or pull the stop plank 30 to control its slanting angle. As mentioned above, the holding frame 20 is provided thereon with the index hand 22 pointing to the graduation ruler 64 on the upper connecting rod 60; therefore when the hand wheel 41 is turned to micro-adjust the stop plank, the upper connecting rod 60 is moved back or forth according to the angle graduations indicated on the angle graduation ruler 64 by the index hand 22 so as to micro-adjust and position the stop plank 30 at an expected angle precisely and quickly.

While the preferred embodiment of the invention has been described above, it will be recognized and understood that various modifications may be made therein and the appended claims are intended to cover all such modifications that may fall within the spirit and scope of the invention.

1. A micro-adjusting device for the angle atop plank of a planer comprising: a wood conveying table, said wood conveying table connected with a holding frame at one side, said holding frame connected with a stop plank, said stop plank positioned at one side on the topside of said wood conveying table for positioning a wood material, and characterized by:
A hand wheel unit composed of a hand wheel and a worm, said worm actuated by said hand wheel to rotate, said worm vertically inserted in a preset part of said holding frame:
A transmission rod transversely inserted in a preset part of said holding frame, said transmission rod having one end formed with a worm wheel, said worm wheel meshed with said worm of said hand wheel unit, said transmission rod having the other end formed with a transmission gear:
An upper connecting rod having its front end pivotally connected with a preset part on the rear wall of said stop plank, said upper connecting rod having its rear end formed with a guiding groove, said guiding groove having its upper edge provided with multiple row teeth, said multiple row teeth meshed with said transmission gear of said transmission rod:
A lower connecting rod having its rear end pivotally connected with said holding frame, said lower connecting rod having its front end pivotally connected with said stop plank: and
Said hand wheel turned to actuate said upper connecting rod to move back and forth through said worm, said upper connecting rod pulling or pushing said stop plank, said stop plank able to be freely adjusted and positioned at a required angle by the turning fulcrums respectively formed at the front and the rear pivotal joint of said lower connecting rod.

2. The micro-adjusting device for the angle stop plank of a planer as claimed in claim 1, wherein said holding frame has an accommodating space formed in the center for receiving said upper connecting rod therein and a locking handle transversely and pivotally inserted in the opposite side of said transmission rod, said locking handle having its end screwed with a lock block, said locking block fitted and limited to rotate in the opposite side of said guiding groove of said upper connecting rod, said locking block able to tighten or release said upper connecting rod when said locking handle is turned around.

3. The micro-adjusting device for the angle stop plank of a planer as claimed in claim 1, wherein said holding frame is formed integral with a stop base protruding upward on one side abutting said upper connecting rod, and said stop base has a stop block pivotally provided thereon, said stop block able to be turned inward and positioned on said upper connecting rod in due time, said upper connecting rod provided with a bolt base protruding upward at a preset part on the topside and a stop bolt screwed on said bolt base, said stop plank able to be quickly adjusted and positioned at a right angle when said stop bolt and said stop block push against each other.

4. The micro-adjusting device for the angle stop plank of a planer as claimed in claim 1, wherein said lower connecting rod is shaped a plate having a stop bolt screwed at a preset location on the topside, said stop bolt exactly pushing against a preset part on the rear wall of said stop plank when said stop plank is adjusted, thus said stop plank able to be quickly adjusted and positioned at an exterior angle of 45 degrees.

5. The micro-adjusting device for the angle stop plank of a planer as claimed in claim 1, wherein said upper connecting rod has a stop bolt screwed at a preset location on the topside, said stop bolt exactly pushing against a preset part on the topside of said lower connecting rod when said stop plank is adjusted, thus said stop plank able to be quickly adjusted and positioned at an interior angle of 45 degrees.

6. The micro-adjusting device for the angle stop plank of a planer as claimed in claim 1, wherein said upper connecting rod has the topside above said guiding groove provided with a graduation ruler having angle graduations marked thereon, and said holding frame has its topside provided with an index hand pointing to said graduation ruler to indicate a positioning angle of said stop plank after said stop plank is adjusted.

7. The micro-adjusting device for the angle stop plank of a planer as claimed in claim 1, wherein said multiple row teeth in said guiding groove of said upper connecting rod is a rack directly fixed in said guiding groove from the upper side of said upper connecting rod.
